(19) United States
(12) Patent Application Publication
(10) Pub. No.: US 2015/0267677 A1
(43) Pub. Date: Sep. 24, 2015

(54) APPARATUS FOR PERMANENT ENERGY

(71) Applicant: Sinsaku Imaya, Kagoshima-shi (JP)

(72) Inventor: Sinsaku Imaya, Kagoshima-shi (JP)

(21) Appl. No.: 14/725,853

(22) Filed: May 29, 2015

Related U.S. Application Data
(63) Continuation-in-part of application No. PCT/JP2013/082476, filed on Dec. 3, 2013.

(30) Foreign Application Priority Data
Dec. 3, 2012 (JP) 2012-289395

(51) Int. Cl. F03B 17/02

(52) U.S. Cl. CPC F03B 17/02

(57) ABSTRACT

By providing wheels 6A and wheels 6B respectively to a shaft 5A and a shaft 5B each supported by bearings and arranged one above the other, placing lines of gas bottles 8 on the wheels 6A and the wheels 6B to make lines of gas bottles 8 on one side of the shaft 5 and lines of gas bottles 8 on the other side of the shaft 5A, the lines of gas bottles 8 on one side and corresponding ones of the lines of gas bottles 8 on the other side being continuous with one another, generating buoyancy force through putting the lines of gas bottles 8 on one side into a water tank, and generating gravity force to be exerted on the lines of gas bottles 8 on the other side, torque for driving a generator 10 is given to the shaft 5A.

### CROSS-REFERENCE TO RELATED APPLICATION

This application is a continuation of International Application No. PCT/JP2013/082476 filed on Dec. 3, 2013, which is based upon and claims the benefit of priority under 35 U.S.C. sec. 119 (a) on the prior Japanese Patent Application No. 2012-289395, filed on Dec. 3, 2012, the entire contents of which are incorporated herein by reference.

### TECHNICAL FIELD

The present invention relates to an apparatus for permanent energy that produces rotational movements using buoyancy and gravity.

### BACKGROUND ART

Among current electricity generation are ones owing to water power, wind power, geothermal heat, wave power, fossil fuel and nuclear power. However, when fossil fuel is burned, CO₂, a source of air pollution, becomes produced. As to nuclear power generation, spent fuel produces a high level of radioactive substances under normal operation. These radioactive substances become piled up on the earth, and do not decrease even after a few, hundreds, or tens of thousands of years. Since radioactive substances destroy cells and lives of every living thing, there is a problem in that radioactive substances lead to extinction of humankind.

The present invention has been made to solve the above points at issue, and an object thereof is to provide an apparatus for permanent energy that rotates a rotational output shaft using differences between buoyancy and gravity and that generates electricity by connecting the rotational output shaft to a generator.

### SUMMARY OF INVENTION

In order to achieve the above object, according to the present invention, there is provided an apparatus for permanent energy A, including providing wheels 6A and wheels 6B respectively to a shaft 5A and a shaft 5B arranged one above the other and each supported by bearings, forming endless lines of gas bottles 8 hung down from each of one side and the other side of the shaft 5A by making the lines of gas bottles 8 engaged with the wheels 6A and the wheels 6B, the endless lines of gas bottles 8 each consisting of gas bottles 8A each linked together through joints 8B, generating buoyancy force by putting the lines of gas bottles 8 on one side into a water tank 4, generating gravity force exerted on the lines of gas bottles 8 on the other side, and giving torque for driving a generator 10 to the shaft 5A.

### Advantageous Effects of Invention

This apparatus for permanent energy, without giving special energy from the outside to the apparatus, enables the generation of electricity by actively using buoyancy and gravity.

Additionally, in the case of this apparatus for permanent energy, an increase in the amount of CO₂, radiation leakage and the like do not occur.

### BRIEF DESCRIPTION OF DRAWINGS

FIG. 1 is an approximate sectional side elevation of an apparatus for permanent energy using vertical-type gas bottles according to one embodiment of the present invention.

FIG. 2 is an explanatory diagram of devices for preventing water pressure.

FIG. 3 is a front elevation of the same apparatus for permanent energy.

FIG. 4 is a back elevation of the same apparatus for permanent energy.

FIG. 5 is a front elevation of an apparatus for permanent energy according to another embodiment of the present invention.

FIG. 6 is a back elevation of the same apparatus for permanent energy.

### DETAILED DESCRIPTION OF THE INVENTION

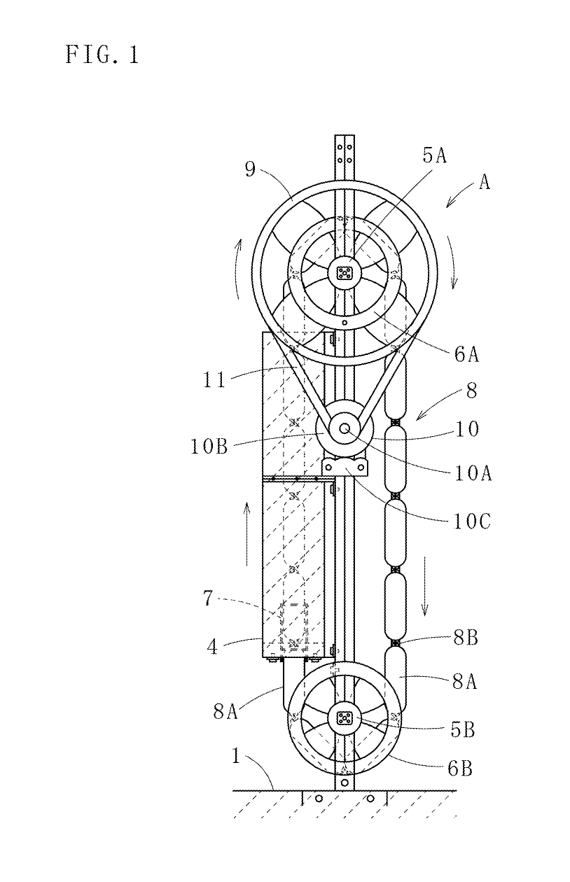

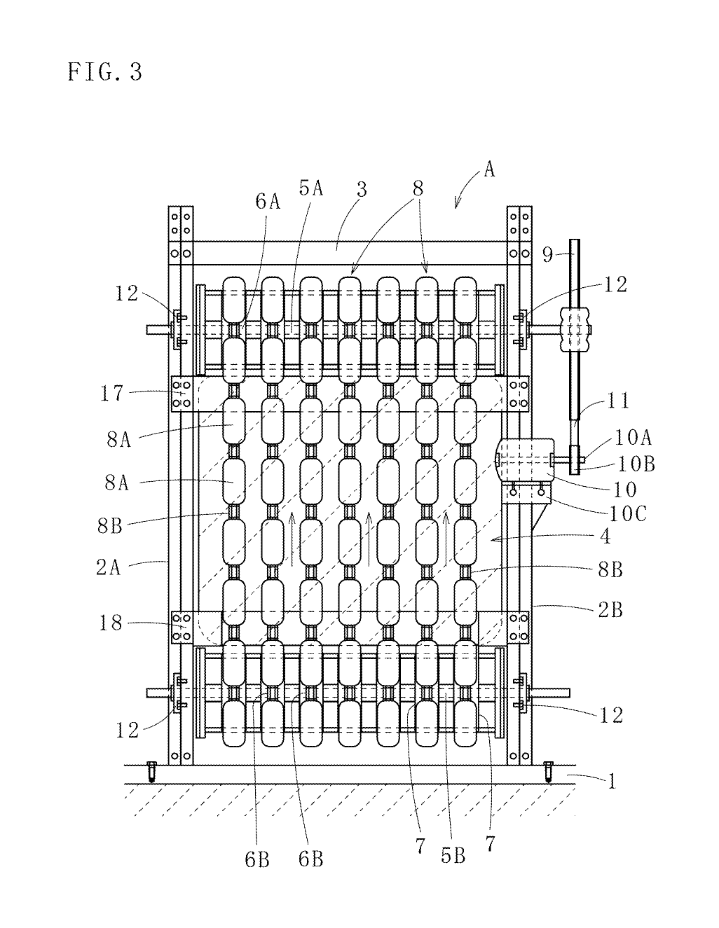

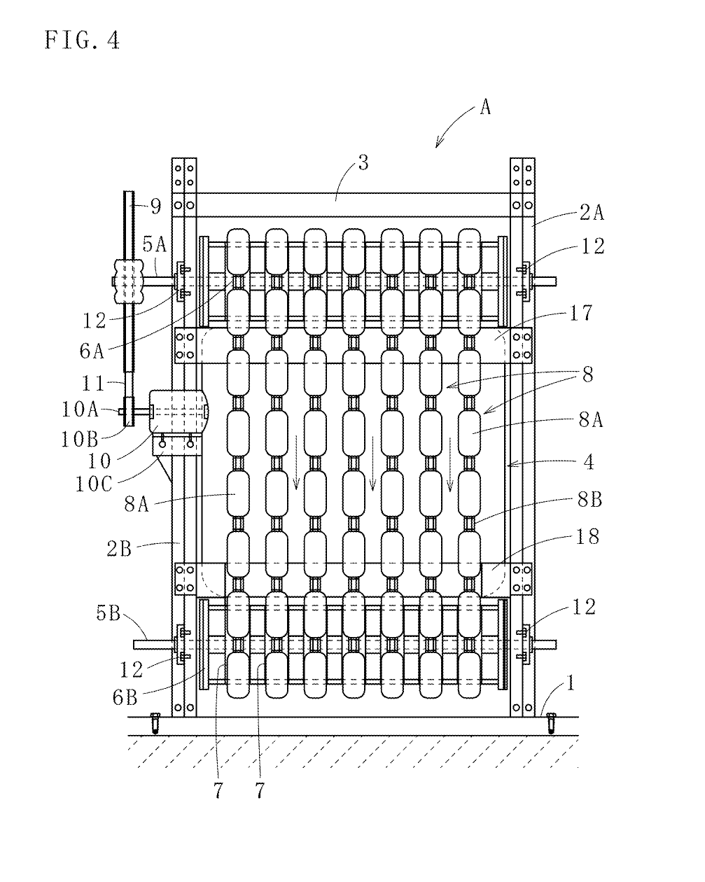

As illustrated in FIGS. 1 to 4, an apparatus for permanent energy A according to one embodiment of the present invention has a basic frame 1 placed on an anchored base, a prop 2A and a prop 2B each arranged standing on the basic frame 1, a joist 3 bolted to the uppermost portions of both of the props 2A and 2B, and a shaft 5A and a shaft 5B respectively supported at the upper parts of the props 2A and 2B and at the lower parts of the props 2A and 2B through bearings 12 and each provided in a rotatable manner. As illustrated in FIGS. 3 and 4, seven wheels 6A and seven wheels 6B were respectively arranged at equal intervals on the shaft 5A at the upper part and the shaft 5B at the lower part.

Additionally, a water tank 4 that makes lines of vertical-type gas bottles 8 described later generate buoyancy force becomes installed to the props 2A and 2B through fitting members 17 and 18.

Each of the lines of vertical-type gas bottles 8 consists of sixteen gas bottles 8A linked together through joints 8B, and is engaged with a corresponding one of the seven wheels 6A provided to the shaft 5A at the upper part and a corresponding one of the seven wheels 6B provided to the shaft 5B at the lower part.

At the bottom of the water tank 4, in response to seven lines of vertical-type gas bottles 8, seven cylinders 7 are provided, and the lines of vertical-type gas bottles 8 pass through the inside of the water tank 4. The cylinders 7 have a length that is equal to an addition of a length of a single gas bottle 8A and a length of a single joint 8B, and one or two of the gas bottles 8A are always fitted inside each of the cylinders 7, preventing leakage of water that is in the water tank 4. As illustrated in FIGS. 1, 3 and 4, there are a total of 112 gas bottles 8A. 56 of the gas bottles 8A are on the side of the water tank (one side), and the other 56 are on a gravity side (the other side). There are always 28 of the gas bottles 8A inside the water tank 4, and on the gravity side, there are 42 of the gas bottles 8A generating gravity force.

As illustrated in FIGS. 1, 3 and 4, a large wheel 9 is provided on an end of the shaft 5A at the upper part, and this large wheel 9 is connected through a belt 11 with a small wheel 10B provided to a rotating shaft 10A of a generator 10 provided below the large wheel 9 through a supporting stand 10C. When the shaft 5A rotates, the rotating shaft 10A of the generator 10 revolves.

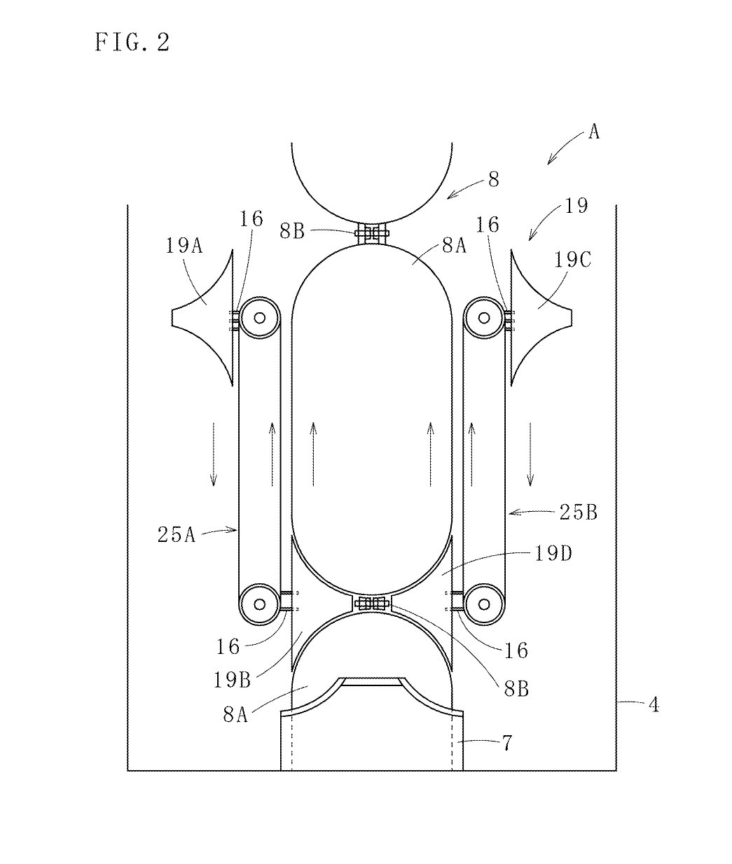

FIG. 2 illustrates devices for preventing water pressure 19 arranged immediately above one of the cylinders 7. The devices for preventing water pressure 19 are arranged opposed to each other. In between the vertically adjacent gas bottles 8A, triangular pyramid shaped occluding members 19A and 19B or triangular pyramid shaped occluding members 19C and 19D become automatically inserted, which alleviates water pressure exerted on the gas bottles 8A, and at the same time, prevents water leakage from interspace between the cylinders 7 and the lines of gas bottles 8. The occluding members 19A and 19B and the occluding members 19C and 19D each have a halved structure, and are respectively attached to a chain conveyer 25A and a chain conveyer 25B that are made in accordance with pitches between each of the gas bottles 8A and joints of the lines of gas bottles 8 and arranged perpendicularly. The chain conveyer 25A and the chain conveyer 25B are respectively coupled to the occluding members 19A and 19B and the occluding members 19C and 19D through fasteners 16.

These devices 19 may be omitted by increasing the length of the cylinders 7.

In the case of this apparatus for permanent energy A, the lines of gas bottles 8 passing through the water tank 4 and arranged on one side move upward due to the generation of buoyancy force, and gravity becomes exerted on the lines of gas bottles 8 arranged on the other side. As a result, the shaft 5A rotates, and the generator 10 revolves through the large wheel 9, the belt 11 and the small wheel 10B, thereby generating electricity.

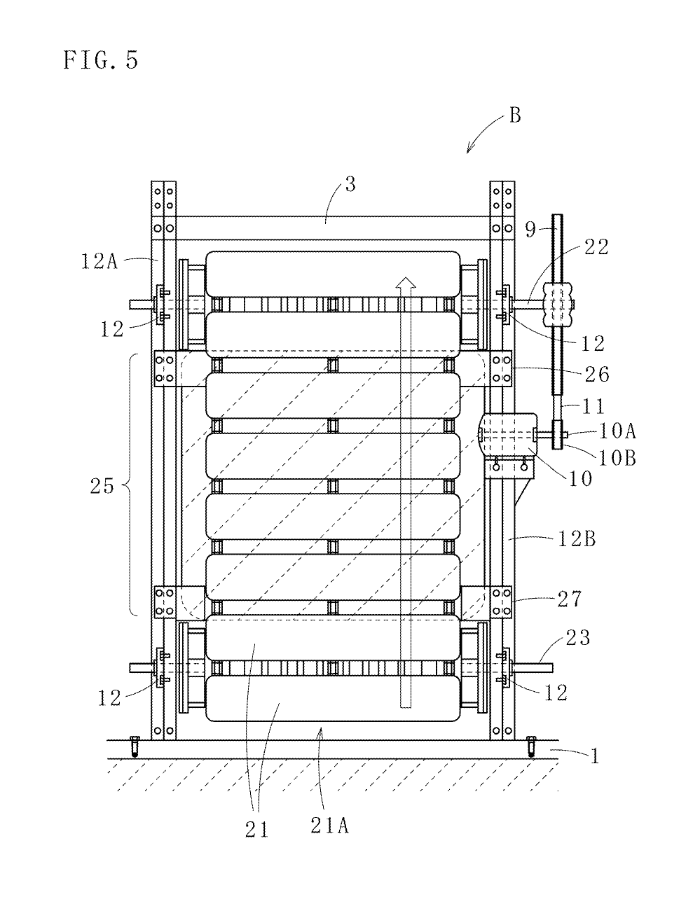

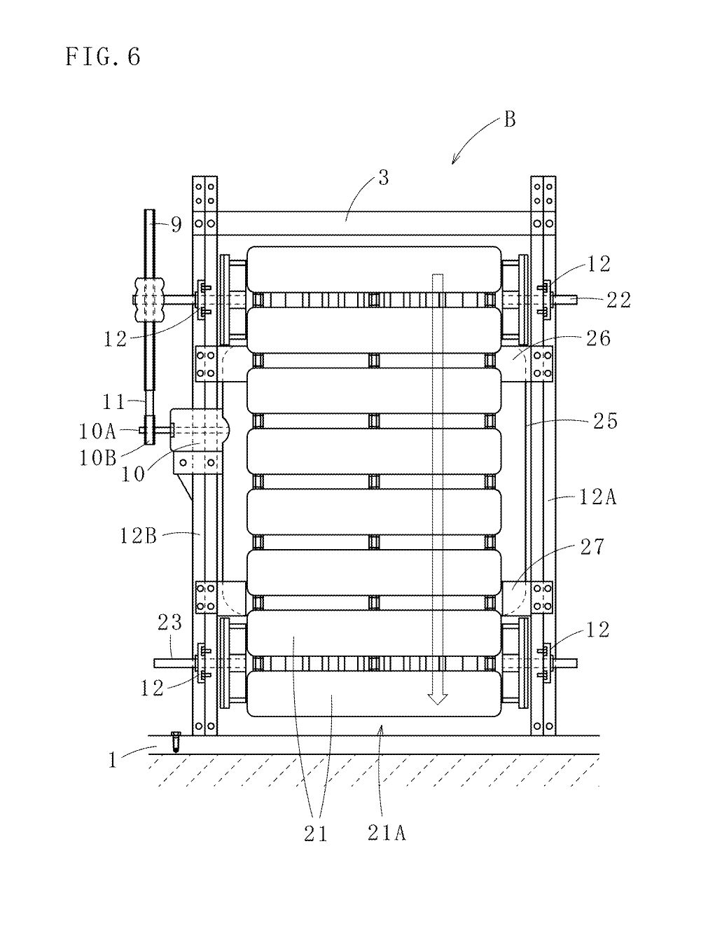

FIGS. 5 and 6 illustrate an apparatus for permanent energy B according to another embodiment of the present invention. A line of horizontal-type gas bottles 21A becomes formed by horizontally arranging long gas bottles 21 and linking the horizontal-type gas bottles 21 together at the center and both sides by joints in a flexible manner. The line of gas bottles 21A is ring-shaped, and is engaged with wheels provided to a shaft 22 at the upper part and wheels provided to a shaft 23 at the lower part. Both shafts 22 and 23 are held by props 12A and 12B by means of bearings 12.

Four of the horizontally-arranged gas bottles 21 placed on one side of lines of wheels go into a water tank 25. The water tank 25 is fixed to the props 12A and 12B through fitting members 26 and 27.

At the bottom of the water tank 25, in order to avoid water leakage, for example, devices for preventing water pressure such as ones 19 illustrated in FIG. 2 are provided.
In the case of this apparatus for permanent energy B, as with the apparatus for permanent energy A, by using buoyancy of the part of the line of gas bottles 21A on one side and gravity of the part of the line of gas bottles 21A on the other side, the shaft 22 is made to rotate, a generator 10 is made to rotate, and electricity is generated.

### REFERENCE SIGNS LIST

A: apparatus for permanent energy, 1: basic frame, 2A, 2B: prop, 3: joist, 4: water tank, 5A, 5B: shaft, 6A, 6B: wheel, 7: cylinder, 8: line of gas bottles, 8A: gas bottle, 8B: joint, 9: large wheel, 10: generator, 10A: rotating shaft, 10B: small wheel, 10C: supporting stand, 11: belt, 12: bearing, 12A, 12B: prop, 16: fastener, 17, 18: fitting member, 19: device, 19A, 19B, 19C, 19D: occluding member, B: apparatus for permanent energy, 21: gas bottle, 21A: line of gas bottles, 22, 23: shaft, 25: water tank, 25A, 25B: chain conveyer, 26, 27: fitting member

1. An apparatus for permanent energy, comprising:
providing wheels 6A and wheels 6B respectively to a shaft 5A and a shaft 5B each supported by bearings and arranged one above the other;
forming endless lines of gas bottles 8 hung down from each of one side and the other side of the shaft 5A by making the lines of gas bottles 8 engaged with the wheels 6A and the wheels 6B, the endless lines of gas bottles 8 each consisting of gas bottles 8A each linked together through joints 8B;
generating buoyancy force by putting the lines of gas bottles 8 on one side into a water tank 4;
generating gravity force in the lines of gas bottles 8 on the other side; and
giving torque for driving a generator 10 to the shaft 5A.

2. The apparatus for permanent energy according to claim 1, wherein
each of the lines of gas bottles consists of vertically-arranged gas bottles.

3. The apparatus for permanent energy according to claim 1, wherein
each of the lines of gas bottles consists of horizontally-arranged gas bottles.
